(19) United States
(12) Patent Application Publication
(10) Pub. No.: US 2007/0259679 A1
(43) Pub. Date: Nov. 8, 2007

(54) Method and System for Communicating a Multimedia Message

(75) Inventors: Xiaoling Shao, Shanghai (CN); Lei Feng, Shanghai (CN); Jianwen Tu, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,011

(22) PCT Filed: Jul. 4, 2005
(86) PCT No.: PCT/IB05/52210

§ 371 Date: Jan. 12, 2007

(30) Foreign Application Priority Data
Jul. 15, 2004 (CN) 200410054411.5

(51) Int. Cl. H04Q 7/20; H04B 7/00

(52) U.S. Cl. 455/466; 370/310

(57) ABSTRACT

The method according to the invention can be used for communicating a multimedia message from a transmitter (40) via a terminal (10) to a further terminal (20). The method comprises: the terminal (10) receiving a notification including address information of the multimedia message from the transmitter (40); the terminal (10) detecting a further terminal (20) capable of receiving at least part of the multimedia message; the terminal (10) sending address information from the further terminal (20) to the transmitter (40) or vice versa; the further terminal (20) receiving the multimedia message on the basis of the address information. In this way, the multimedia message is communicated quickly and securely from a transmitter (40) via a terminal (10) to a further terminal (20).

### FIELD OF THE INVENTION

The present invention relates to a method for communicating a multimedia message from a transmitter via a terminal to a further terminal, the method comprising the terminal receiving a notification of the multimedia message from the transmitter.

The present invention also relates to a system for communicating a multimedia message from a transmitter via a terminal to a further terminal, to a terminal for communicating a multimedia message from a transmitter to a further terminal and to a further terminal for receiving a multimedia message from a transmitter via a terminal.

### BACKGROUND OF THE INVENTION

A method and system for communicating a multimedia message from a transmitter via a terminal to a further terminal according to the preamble is known from the document entitled “3GPP TS 23.140 V6.4.0 (2003-12), 3rd Generation Partnership Project; Technical Specification Group Terminals; Multimedia Messaging Service(MMS); functional description; Stage 2 (release 6)”, pages 30 and 58. This document describes a standard which allows users to send and receive multimedia messages comprising formatted text, graphics, photographic images, audio and video clips. In the known method, a terminal, e.g. a mobile phone, receives a notification of a multimedia message and forwards the multimedia message to a further terminal, e.g. a PC, without receiving the multimedia message itself. In order to be able to forward the multimedia message to the further terminal, the terminal needs to know the address of the further terminal.

However, the address of the further terminal is not automatically known by the terminal that receives the notification of the multimedia message. The address can be entered into the terminal manually by a user, but this is cumbersome in that it is relatively a slow and error-prone procedure.

### OBJECT AND SUMMARY OF THE INVENTION

An object of the invention is to provide a method for communicating a multimedia message from a transmitter via a terminal to a further terminal according to the preamble which method is relatively quick and fail-safe. This object is achieved by the method for communicating a multimedia message according to the invention, which is characterized in that the method further comprises the terminal detecting a further terminal capable of receiving at least part of the multimedia message, the terminal sending address information from the further terminal to the transmitter or vice versa, the further terminal receiving the multimedia message on the basis of the address information. In this way, the terminal can detect the presence of the further terminal and can automatically obtain the address of the further terminal. Alternatively, the further terminal can, once detected by the terminal, obtain the address of the multimedia message from the terminal. In both cases, the multimedia message can automatically be received by the further terminal on the basis of the address so obtained.

A further advantageous effect of the method according to the invention is that the further terminal is available when the user forwards the multimedia message to the further terminal or sends address information about the location of the multimedia message to the further terminal. This avoids the situation wherein the user cannot receive the multimedia message when the further terminal is switched off.

An embodiment of the method according to the invention is characterized in that the method further comprises the address information including address information of the multimedia message, the further terminal downloading the multimedia message from a location indicated by the address information of the multimedia message. By this method the terminal detects the further terminal and sends the address information of the multimedia message to the further terminal. Then the further terminal is able to receive the multimedia message by downloading the multimedia message from the address information of the multimedia message.

Another embodiment of the method according to the invention is characterized in that the method further comprises the address information including address information of the further terminal, and the terminal forwarding the multimedia message to the further terminal. By this method the terminal detects the further terminal and obtains the address of the further terminal. The terminal sends the detected address information of the further terminal to the transmitter so that the terminal is able to forward the multimedia message to the further terminal.

In order to choose a suitable further terminal conveniently, the terminal may detect the presence of the further terminal in its vicinity. For example, the terminal detects the further terminal by a Bluetooth, wireless LAN or infrared interface.

Another embodiment of the method according to the invention is characterized in that the method further comprises the terminal detecting a plurality of further terminals capable of receiving at least part of the multimedia message, and selecting one of the further terminals to receive at least part of the multimedia message. The user can select one of the further terminals which is closest to him to receive the multimedia message. He can also select one further terminal to receive part of the multimedia message, and other further terminals to receive the remaining part of the multimedia message. It is to the user's comfort when he selects the further terminal to receive the multimedia message.

### BRIEF DESCRIPTION OF THE DRAWINGS

The above object and features of the present invention will be more apparent from the following description of the preferred embodiments with reference to the drawings, wherein:

FIG. 1 shows a flow chart of a first embodiment of the method for communicating a multimedia message from a transmitter via a terminal to a further terminal according to the invention;

FIG. 2 shows a flow chart of a second embodiment of the method for communicating a multimedia message from a transmitter via a terminal to a further terminal according to the invention;

FIG. 3 shows a diagram of an embodiment of the system for communicating a multimedia message from a transmitter via a terminal to a further terminal according to the invention.

Throughout the drawings, the same reference numerals indicate similar or corresponding features or functions.

### DETAILED DESCRIPTION OF THE INVENTION

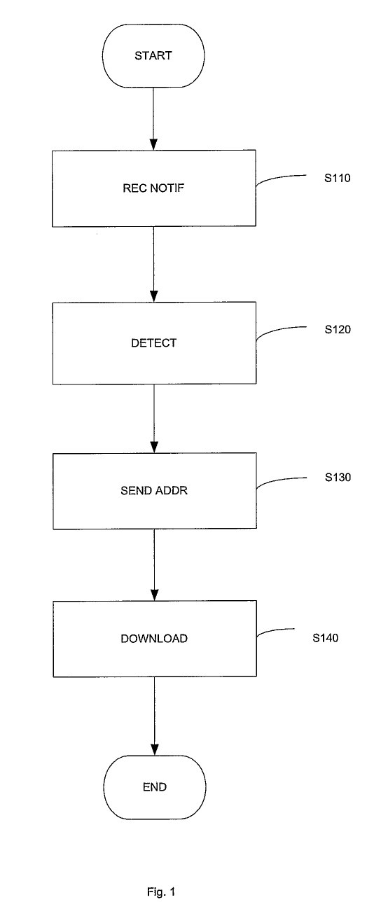

FIG. 1 shows a flow chart of a first embodiment of the method for communicating a multimedia message from a transmitter via a terminal to a further terminal. In this embodiment, a mobile phone, i.e. the terminal, receives a notification of a multimedia message from a server, i.e. the transmitter (step 110). The notification includes a location address of the multimedia message that can be used to receive the multimedia message from the server. Preferably, the location address that is conveyed in the notification is at least valid throughout the message expiry period, until the successful reception of the multimedia message or until the multimedia message is rejected.

The mobile phone detects the presence of a PC, i.e. the further terminal capable of receiving at least part of the multimedia message, in its vicinity, e.g. at home or in the office (step 120). Nowadays mobile phones with a Bluetooth interface become more and more popular, e.g. Nokia 6820, Sony Ericsson P900. Bluetooth radio technology provides a universal bridge to existing data networks, a peripheral interface, and a mechanism to form small private ad hoc groupings of connected devices away from fixed network infrastructures. Designed to operate in a noisy radio frequency environment, the Bluetooth radio uses a fast acknowledgement and frequency hopping scheme to make the link robust. The mobile phone with a Bluetooth interface can detect a PC which is also equipped with a Bluetooth interface and establish a network connection.

Next, the mobile phone sends the address information of the multimedia message to the PC (step 130), so that the PC can retrieve the multimedia message instead of the mobile phone (step 140).

The PC can retrieve the multimedia message by downloading it from the location address as described in the document “3GPP TS 23.140 V6.4.0 (2003-12), 3rd Generation Partnership Project; Technical Specification Group Terminals; Multimedia Messaging Service(MMS); functional description; Stage 2 (release 6)” as follows: (1) the PC sends a multimedia message retrieve request (MM1_retrieve.REQ) to the server; (2) the server directs a multimedia message retrieve response (MM1_retrieve.RES) to the PC; (3) the PC downloads the multimedia message from the location address of the multimedia message indicated in the notification. After the download has finished, the PC may send a retrieve acknowledgement to the server and the mobile phone. The user of the mobile phone can recognise that the multimedia message is located on the PC. The user can then experience the content of the multimedia message on the PC if he/she likes.

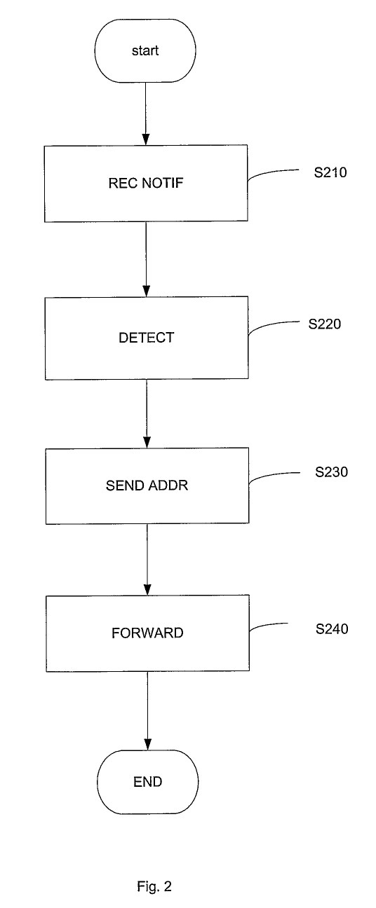

FIG. 2 shows a flow chart of a second embodiment of the method for communicating a multimedia message from a transmitter via a terminal to a further terminal. In this embodiment, a mobile phone, i.e. the terminal, with a Bluetooth interface receives a notification of a multimedia message from a server, i.e. the transmitter, (step 210) and detects in its vicinity the presence of a PC, i.e. the further terminal capable of receiving at least part of the multimedia message, the PC also having a Bluetooth interface (step 220). Next, a communication link is set up between the mobile phone and the PC over Bluetooth, which enables the mobile phone to obtain the address of the PC automatically. Next, the mobile phone send the address of the PC to the server (step 230). Finally, the mobile phone forwards the multimedia message to the PC as described in the document “3GPP TS 23.140 V6.4.0 (2003-12), 3rd Generation Partnership Project; Technical Specification Group Terminals; Multimedia Messaging Service(MMS); functional description; Stage 2 (release 6)” as follows (step 240): (1) the mobile phone issues a multimedia message forward request (MM1_forward.REQ) to the server, which contains multimedia message control information; (2) the server responds with a multimedia message forward response (MM1_forward.RES), which provides the status of the request. The multimedia message forward request unambiguously refers to the corresponding multimedia message forward response. The PC then receives the multimedia message according to the multimedia message forward response.

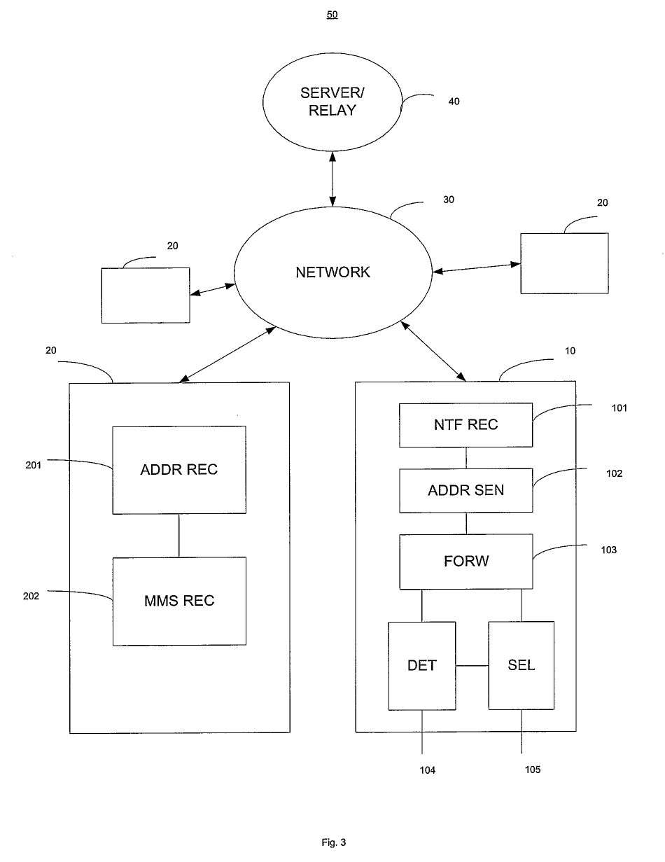

FIG. 3 shows a diagram of an embodiment of the system 50 according to the present invention, which system 50 is arranged for communicating a multimedia message from a transmitter 40 via a terminal 10 to a further terminal 20.

In this embodiment the transmitter 40 is formed by a server/relay 40 which is responsible for storing and handling of incoming messages that are received from a network 30 and outgoing messages that are submitted to the network 30 and for transferring messages between different messaging systems. The network 30 can for instance be a 2G mobile phone network, a 3G mobile phone network or the internet.

The terminal 10 comprises means 101 for receiving a notification of the multimedia message from the transmitter 40, means 104 for detecting a further terminal 20 capable of receiving at least part of the multimedia message, and means 102 for sending address information from the further terminal 20 to the transmitter 40 or for sending address information from the transmitter 40 to the further terminal 20. The further terminal 20 comprises means 202 for receiving the multimedia message on the basis of the address information.

The address information may include address information of the multimedia message. Means 202 in the further terminal 20 can be arranged for downloading the multimedia message from a location indicated by the address information of the multimedia message.

The address information may include address information of the further terminal 20. The terminal 10 comprises means 103 for forwarding the multimedia message to the further terminal 20.

For user's convenience, means 104 in the terminal 10 can be arranged for detecting the further terminal in its vicinity.

Means 104 in the terminal 10 can also be arranged for detecting a plurality of further terminals 20 capable of receiving at least part of the multimedia message. The terminal 10 preferably comprises means 105 for selecting one of the farther terminals 20 to receive at least part of the multimedia message. The user can select the closest further terminal 20 to receive the multimedia message. He can also select one further terminal 20 which has best performance of experiencing the multimedia message, such as the speed and the stability of receiving the multimedia message, the screen of display, etc.

The scope of the invention is not limited to the embodiments explicitly disclosed. The invention is embodied in each new characteristic and each combination of characteristics. Any reference signs do not limit the scope of the claims. The word “comprising” does not exclude the presence of other elements or steps than those listed in the claims. Use of the word “a” or “an” preceding an element does not exclude the presence of a plurality of such elements.

1. A method for communicating a multimedia message from a transmitter via a terminal to a further terminal, the method comprising:
the terminal receiving a notification of the multimedia message from the transmitter;
the terminal detecting a further terminal capable of receiving at least part of the multimedia message;
the terminal sending address information from the further terminal to the transmitter or vice versa;
the further terminal receiving the multimedia message on the basis of the address information.

2. A method according to claim 1, wherein the method further comprises:
the address information including address information of the multimedia message;
the further terminal downloading the multimedia message from a location indicated by the address information of the multimedia message.

3. A method according to claim 1, wherein the method further comprises:
the address information including address information of the further terminal;
the terminal forwarding the multimedia message to the further terminal.

4. A method according to claim 1, wherein the method further comprises:
the terminal detecting the further terminal in its vicinity.

5. A method according to claim 1, wherein the method further comprises:
the terminal detecting a plurality of further terminals capable of receiving at least part of the multimedia message;
selecting one of the further terminals to receive at least part of the multimedia message.

6. A system (50) for communicating a multimedia message from a transmitter (40) via a terminal (10) to a further terminal (20), the terminal (10) comprising:
means (101) for receiving a notification of the multimedia message from the transmitter (40);
means (104) for detecting a further terminal capable of receiving at least part of the multimedia message;
means (102) for sending address information from the further terminal (20) to the transmitter(40) or vice versa;
and the further terminal (20) comprising:
means (202) for receiving the multimedia message on the basis of the address information.

7. A system (50) according to claim 6, wherein:
the address information includes address information of the multimedia message;
and the further terminal (20) comprises:
means (201) for receiving address information of the multimedia message from the terminal (10);
means (202) arranged for downloading the multimedia message from a location indicated by the address information of the multimedia message.

8. A system (50) according to claim 6, wherein:
the address information includes address information of the further terminal (20);
the terminal (10) comprises means (103) for forwarding the multimedia message to the further terminal (20).

9. A system (50) according to claim 6, wherein means (104) are arranged for detecting the further terminal in its vicinity.

10. A system (50) according to claim 6, wherein:
means (104) are arranged for detecting a plurality of further terminals capable of receiving at least part of the multimedia message;
and the terminal (10) comprises:
means (105) for selecting one of the further terminals to receive at least part of the multimedia message.

11. A terminal (10) for communicating a multimedia message from a transmitter (40) to a further terminal (20), the terminal (10) comprises:
means (101) for receiving a notification of the multimedia message from the transmitter;
means (104) for detecting a further terminal capable of receiving at least part of the multimedia message;
means (102) for sending address information from the further terminal (20) to the transmitter (40) or vice versa.

12. A further terminal (20) for receiving a multimedia message from a transmitter (40) via a terminal (10), the further terminal (20) comprising:
means (202) for receiving the multimedia message on the basis of the address information.
